(19) United States
(12) Patent Application Publication
(10) Pub. No.: US 2023/0026687 A1
(43) Pub. Date: Jan. 26, 2023

(54) SILICON PHOTONIC SMOKE DETECTOR

(71) Applicant: Carrier Corporation, Palm Beach Gardens, FL (US)

(72) Inventor: Michael Lawrence Golob, Bradenton, FL (US)

(21) Appl. No.: 17/868,919

(22) Filed: Jul. 20, 2022

Related U.S. Application Data
(60) Provisional application No. 63/224,114, filed on Jul. 21, 2021.

(51) Int. Cl. G01N 21/53; G02B 6/12

(52) U.S. Cl. CPC G01N 21/53; G02B 6/12019; G02B 2006/12138; G02B 2006/12107; G02B 2006/12121

(57) ABSTRACT

A chamberless smoke detector includes a source laser, a grating coupler, a transmitting optical phase array, a receiving optical phase array, and a processing unit.

### CROSS-REFERENCE TO RELATED APPLICATIONS

This application claims the benefit of Provisional Application No. 63/224,114 filed Jul. 21, 2021, the disclosure of which is incorporated herein by reference in its entirety.

### BACKGROUND

The embodiments disclosed herein relate to smoke detectors, and more particularly, smoke detectors that employ Light Detection and Ranging (LiDAR).

Smoke detectors, such as commercial smoke detectors, commonly use infrared light scattering, ionization-based techniques or photoelectric techniques. These methods may not provide the desired amount of detail, may have difficulty detecting trace amounts of smoke, may consume more power than desired, and may have a smaller sensing region than desired. LiDAR technology has been proposed as an alternative but implementation has been hindered by component complexity, the size of the mechanical components, and power consumption. An improved LiDAR smoke detector is needed.

### BRIEF DESCRIPTION

Disclosed is a chamberless smoke detector comprising a source laser, a grating coupler, a transmitting optical phase array, a receiving optical phase array, and a processing unit.

In addition to one or more of the features described above, or as an alternative, the grating coupler, transmitting optical phase array, receiving optical phase array and processing units are elements of a silicon photonics circuit.

In addition to one or more of the features described above, or as an alternative, the source laser is a component of the silicon photonics circuit.

In addition to one or more of the features described above, or as an alternative, the source laser is external to the silicon photonics circuit.

In addition to one or more of the features described above, or as an alternative, the transmitting optical phase array comprises thermal heaters.

In addition to one or more of the features described above, or as an alternative, the receiving optical phase array comprises thermal heaters.

In addition to one or more of the features described above, or as an alternative, the transmitting optical phase array comprises greater than or equal to eight (8) elements.

In addition to one or more of the features described above, or as an alternative, the receiving optical phase array comprises greater than or equal to eight (8) elements.

In addition to one or more of the features described above, or as an alternative, the transmitting optical phase array and the receiving optical phase array comprise the same number of elements.

In addition to one or more of the features described above, or as an alternative, the grating coupler has a focusing grating with a size less than or equal to 630 nanometers (nm).

In addition to one or more of the features described above, or as an alternative, the transmitting optical phase array has a tree-branch architecture.

In addition to one or more of the features described above, or as an alternative, the receiving optical phase array has a tree-branch architecture.

In addition to one or more of the features described above, or as an alternative, the source laser has a wavelength of 900 to 1550 nanometers.

In addition to one or more of the features described above, or as an alternative, the field of view is greater than or equal to 25 degrees. The field of view may be 25 to 90 degrees.

Also disclosed is a method for detecting smoke comprising emitting photons from a transmitting optical phase array that is part of a silicon photonics circuit into an area, receiving backscattered photons from the area with a receiving optical phase array on the silicon photonics circuit, and comparing the emitted photons to the received photons using a processing unit.

In addition to one or more of the features described above, or as an alternative, comparing the emitted photons to the received photons comprises using an algorithm to distinguish smoke from objects and people.

### BRIEF DESCRIPTION OF THE DRAWINGS

The following descriptions should not be considered limiting in any way. With reference to the accompanying drawings, like elements are numbered alike:

FIG. 1 shows an exemplary smoke detector having optical phase arrays.

### DETAILED DESCRIPTION

A detailed description of one or more embodiments of the disclosed apparatus and method are presented herein by way of exemplification and not limitation with reference to the Figures.

Prior methods of smoke detection may not provide the desired amount of detail, may have difficulty detecting trace amounts of smoke, and may consume more power than desired. LiDAR technology has been proposed as an alternative to methods such as photoelectric smoke detection but implementation has been hindered by component complexity, the size of the mechanical components, and power consumption.

Disclosed herein is a chamberless smoke detector comprising a source laser, a grating coupler, a transmitting optical phase array, a receiving optical phase array, and a processing unit. The chamberless smoke detector does not have moving parts, may be small in size and have lower power consumption.

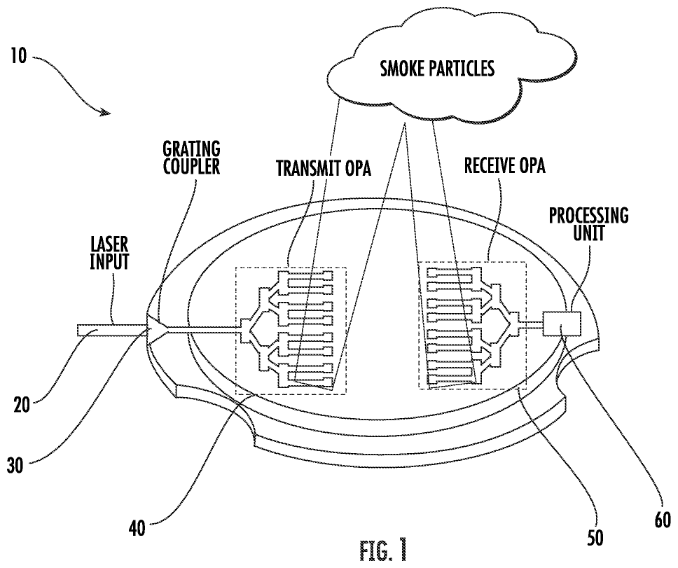

FIG. 1 shows an exemplary chamberless smoke detector 10. Photons 20 from the source laser (not shown) enter the grating coupler 30. Photons from the grating coupler enter the transmitting optical phase array 40. Photons leave the transmitting optical phase array and enter the area being monitored. Backscattered photons (reflected photons) from the monitored area are received by the receiving optical phase array and are then sent to and analyzed by the processing unit 60.

The grating coupler 30, transmitting optical phase array 40 and receiving optical phase array 50 are part of a silicon photonics circuit. The silicon photonics circuit may be contained in a waveguide. The waveguide may be silicon, silicon nitride, or indium phosphide. The waveguide may have a thickness of 200 to 300 nm. The waveguide is placed on top of a wafer. The wafer may be silicon-on-insulator (SOI) or indium phosphide (InP). The source laser may be part of the silicon photonics circuit or may be exterior to the silicon photonics circuit. The source laser may be a fiber laser or a diode laser. Exemplary lasers include vertical-cavity surface-emitting laser (VCSEL), edge emitting laser (EEL), and diode pumped solid state laser (DPSSL). The source laser is controlled by a controller.

The source laser produces light having a wavelength of 900 nanometers (nm) to 1550 nm.

The grating coupler may comprise an edge coupler, a vertical grating coupler or a combination thereof. The grating coupler may have straight gratings or confocal gratings. When the grating coupler has straight gratings a spot size converter (tapered waveguide) may be needed.

The grating coupler is optically connected to the transmitting optical phase array. The transmitting optical phase array comprises elements (sometimes referred to as antenna) which transmit photons in a direction that is out of the plane of the silicon photonics waveguide. The elements may be arranged in a tree branch architecture. The transmitting optical phase array may include greater than or equal to eight (8) elements. The number of elements, arrangement and spacing may be varied to match the application and may affect the size of the field of view. For example, when a smaller field of view is desired a smaller number of elements may be employed. Additionally, the transmitting optical phase array may include on-chip heaters (thermal heaters) to tune the light phase which can also modify the size of the field of view. Multiple optical phase arrays may be used to for different wavelengths. Multiple wavelengths may be used to differentiate nuisance smoke such as smoke from cooking.

The receiving optical phase array comprises elements (sometimes referred to as antenna) which receive light from the monitored area. The receiving optical phase array may include greater than or equal to eight (8) elements. The number of elements, arrangement and spacing may be varied to match the application. The number of elements, arrangement and spacing may affect the field of view. The transmitting optical phase array and the receiving optical phase array may include the same number of elements. The elements may be arranged in a tree branch architecture. Additionally, the receiving optical phase array may include on-chip heaters (thermal heaters) to tune the light phase which can modify the size of the field of view.

The receiving optical phase array transmits the received photons to a processing unit. The processing unit compares the received photons to the transmitted photons and uses an algorithm to evaluate whether smoke is present or not. When smoke is detected the processing unit may include a means for notification of the presence of smoke.

While the Figure and the above description include a single transmitting optical phase array and a single receiving optical phase array it is expressly contemplated that more than one transmitting optical phase array may be used and/or more than one receiving optical phase array may be used.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A chamberless smoke detector comprising a source laser, a grating coupler, a transmitting optical phase array, a receiving optical phase array, and a processing unit.

2. The chamberless smoke detector of claim 1, wherein the grating coupler, transmitting optical phase array, receiving optical phase array and processing units are elements of a silicon photonics circuit.

3. The chamberless smoke detector of claim 2, wherein the source laser is a component of the silicon photonics circuit.

4. The chamberless smoke detector of claim 2, wherein the source laser is external to the silicon photonics circuit.

5. The chamberless smoke detector of claim 1, wherein the transmitting optical phase array comprises thermal heaters.

6. The chamberless smoke detector of claim 1, wherein the receiving optical phase array comprises thermal heaters.

7. The chamberless smoke detector of claim 1, wherein the transmitting optical phase array comprises greater than or equal to eight (8) elements.

8. The chamberless smoke detector of claim 1, wherein the receiving optical phase array comprises greater than or equal to eight (8) elements.

9. The chamberless smoke detector of claim 1, wherein the transmitting optical phase array and the receiving optical phase array comprise the same number of elements.

10. The chamberless smoke detector of claim 1, wherein the grating coupler has a focusing grating with a size less than or equal to 630 nanometers.

11. The chamberless smoke detector of claim 1, wherein the transmitting optical phase array has a tree-branch architecture.

12. The chamberless smoke detector of claim 1, wherein the receiving optical phase array has a tree-branch architecture.

13. The chamberless smoke detector of claim 1, wherein the source laser has a wavelength of 900 to 1550 nanometers.

14. The chamberless smoke detector of claim 1, wherein the field of view is greater than or equal to 25 degrees.

15. A method for detecting smoke comprising emitting photons from a transmitting optical phase array on a silicon photonics circuit into an area, receiving photons from the area with a receiving optical phase array on the silicon photonics circuit, and comparing the emitted photons to the received photons using a processing unit.

16. The method of claim 15, wherein comparing the emitted photons to the received photons comprises using an algorithm to distinguish smoke from objects and people.
